(19) United States
(12) Patent Application Publication
(10) Pub. No.: US 2012/0188133 A1
(43) Pub. Date: Jul. 26, 2012

(54) SPIRALPOLE SMALL ANTENNA SYSTEM

(75) Inventors: Sabah Sabah, Nashua, NH (US); Sergey N. Makarov, Holden, MA (US)

(73) Assignee: DELAWARE CAPITAL FORMATION, INC., Wilmington, DE (US)

(21) Appl. No.: 13/354,408

(22) Filed: Jan. 20, 2012

Related U.S. Application Data
(60) Provisional application No. 61/434,620, filed on Jan. 20, 2011.

(51) Int. Cl. H01Q 1/00

(52) U.S. Cl. 343/720

(57) ABSTRACT

A wireless sensor device, system and method includes a handle/antenna component and probe shaft sensor. A spiralpole loop antenna interfaces with a probe shaft comprising electrical connection to a surface acoustic wave (SAW) sensor device for wireless temperature sensing. Applications include monitoring the internal temperature of the contents of ovens.

### RELATED APPLICATIONS

This application claims the benefit of U.S. Provisional Application No. 61/434,620, filed Jan. 20, 2011; this application is herein incorporated in its entirety by reference.

### FIELD OF THE INVENTION

The invention relates to a wireless sensor device, system and method including a handle/antenna component and probe shaft sensor. More particularly, a spiralpole antenna configured with a surface acoustic wave (SAW) device for wireless temperature sensing.

### BACKGROUND OF THE INVENTION

Temperature sensing of objects being heated can be problematic. Inherently high temperatures limit materials eligible to be used as components. Confinement in enclosures such as ovens can impair direct visual readings. Electromagnetic radiation from heat sources can further limit candidate solutions. Overall size of sensors can be further limited due to the size of the enclosure or dimensions of the object being heated. When multiple objects or multiple locations are simultaneously being heated and sensed, discrimination between sensors can be difficult. Motion within the heating environment can create variations in performance. When flexibility, accuracy and reliability are emphasized, cost and complexity can be deterrents.

### SUMMARY OF THE INVENTION

Embodiments include a system for wireless sensing, the system comprising a spiral-dipole (“spiralpole”) antenna; a probe shaft comprising electrical connection; an acoustic wave device (AWD) sensor device in electrical communication with the spiralpole antenna through the probe shaft. Other embodiments provide a method for wireless sensing comprising providing a spiralpole antenna sensor device; transmitting an excitation signal to the antenna of an AWD; receiving the excitation signal at the spiralpole antenna; reacting, at the AWD, to the excitation signal conveyed from the spiralpole antenna; transmitting from the spiralpole antenna a response signal conveyed from the AWD; and receiving, at a receiver, the response signal.

Embodiments provide a probe system for wireless sensing of at least one measurand, the system comprising a spiral-dipole (spiralpole) antenna component; a probe shaft comprising electrical connection; an acoustic wave device (AWD) sensor in electrical communication with the spiralpole antenna through the probe shaft; wherein the system is configured to communicate with an excitation signal generator and response signal receiver. In additional embodiments, the AWD is a surface acoustic wave (SAW) device; and the AWD is a surface acoustic wave (SAW) resonator device. For other embodiments, the measurand comprises temperature; others comprise at least one measurand in addition to temperature, to which the acoustic wave device is sensitive; and in others the measurand is a measurand other than temperature, to which the acoustic wave device is sensitive. For more embodiments, the spiral-dipole antenna component is non-orthogonal to the probe shaft. In further embodiments, multiple probes operate cooperatively through differential operating frequencies of AWD components in each of the multiple probes. For other further embodiments, the radiation pattern of the probe is omnidirectional; and in others performance is direction-independent; whereby movement and orientation of temperature measurement subject does not impact accuracy or resolution of temperature measurement. In continuing embodiments, the spiral-dipole antenna is mismatched, whereby the radiation pattern is broad. Additional embodiments provide that the spiral-dipole antenna component comprises a helical coil; and in others the spiral-dipole antenna component comprises a helical coil and interfaces with the ground arm at a termination of a proximate loop. For some embodiments, the spiral-dipole antenna component comprises a helical coil and interfaces with the ground arm at an intermediate location between terminal ends of the antenna element of the spiral-dipole antenna component.

Further embodiments provide a probe device for wireless sensing of at least one measurand, the device comprising a spiral-dipole (spiralpole) antenna component; a probe shaft component in electrical communication with the spiral-dipole (spiralpole) antenna component; an acoustic wave device (AWD) sensor in electrical communication with the spiralpole antenna through the probe shaft; wherein the device is configured to communicate with an excitation signal generator and response signal receiver.

Yet further embodiments provide a method for wireless sensing comprising providing a spiral-dipole (spiralpole) antenna sensor device; transmitting an excitation signal to the antenna of an acoustic wave device (AWD); receiving the excitation signal at the spiralpole antenna; reacting, at the AWD, to the excitation signal conveyed from the spiralpole antenna; transmitting from the spiralpole antenna a response signal conveyed from the AWD; and receiving, at a receiver, the response signal. In additional embodiments, the operating frequency range is about 400 MHz to about 700 MHz. For other embodiments, the transmitter antenna of the transmitting step and receiving antenna of the receiving step comprise unitary components. For more embodiments, the transmitter antenna of the transmitting step and receiving antenna of the receiving step comprise multiple components. In continuing embodiments, operational field strengths of about 13.5 dB are produced.

The features and advantages described herein are not all-inclusive and, in particular, many additional features and advantages will be apparent to one of ordinary skill in the art in view of the drawings, specification, and claims. Moreover, it should be noted that the language used in the specification has been principally selected for readability and instructional purposes, and not to limit the scope of the inventive subject matter.

### BRIEF DESCRIPTION OF THE DRAWINGS

FIG. 1 depicts an antenna geometry perspective view of an embodiment configured in accordance with the present invention.

FIG. 2 depicts plan and elevation views of a spiraldipole antenna embodiment with a one turn (loop) antenna configured in accordance with the present invention.

FIG. 3 depicts an elevation detail view of a spiraldipole antenna embodiment with a one turn (loop) antenna configured in accordance with the present invention.

FIG. 4 depicts perspective and elevation sensor-end detail views of an embodiment configured in accordance with the present invention.

FIG. 5 depicts an antenna geometry embodiment perspective view and corresponding dipole representation configured in accordance with the present invention.

FIG. 6 depicts a perspective diagram of a coaxial cable component embodiment configured in accordance with the present invention.

FIG. 7 depicts a cross-section view of another embodiment configured in accordance with the present invention.

FIG. 8 depicts a cross-section view of another embodiment configured in accordance with the present invention.

FIG. 9 is a cross-section view of another embodiment configured in accordance with the present invention.

FIG. 10 is a graph of theoretical versus calculated resonant frequency results for embodiments configured in accordance with the present invention.

FIG. 11 is a flow chart of a method configured in accordance with the present invention.

### DETAILED DESCRIPTION

‘Spiralpole’ (spiral-dipole) antenna embodiments have two radiating parts: the shaft and the one-wing spiral. It performs similarly to a resonant half-wave dipole. A representative dipole's length is:

L_{dipole}=L_{probe}+Lₛₚᵢᵣₐₗ Eq. (1)

where the spiral length, Lₛₚᵢᵣₐₗ, is measured from the opening of the transmission line. For this embodiment, the resonant frequency of the antenna is given by:

$${f}_{res} = \frac{{c}_{0}}{2 ( {L}_{probe} + {L}_{spiral} )} \qquad Eq . ( 2 )$$

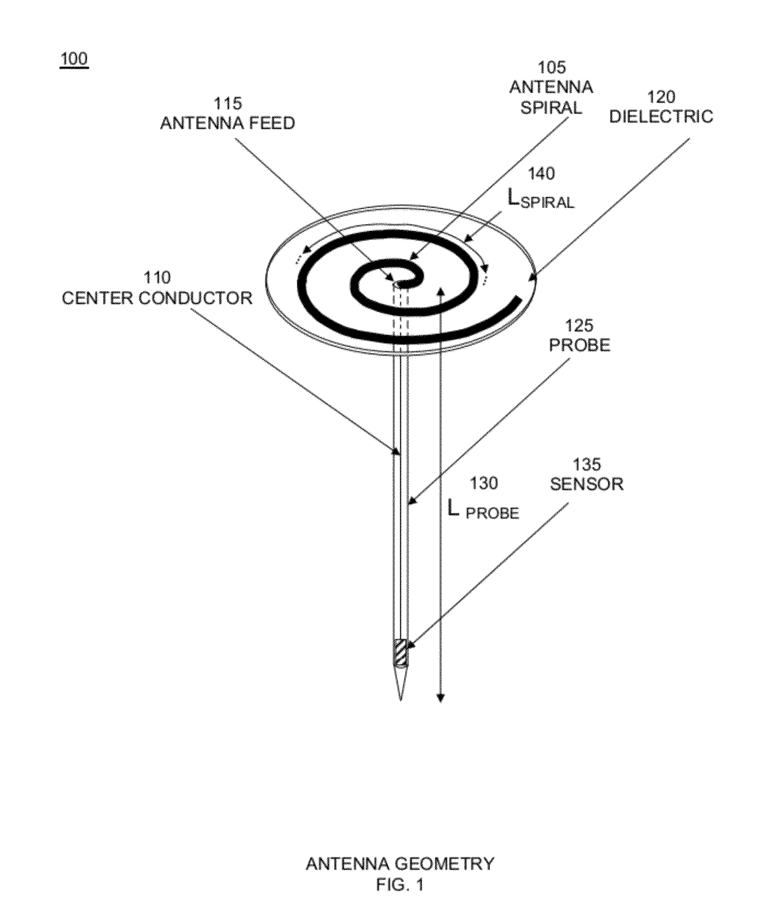

FIG. 1 depicts an antenna geometry perspective view 100 of an embodiment. Spiral 105 connects to center conductor 110 at antenna feed 115. Spiral 105 is coincident with dielectric 120. In embodiments, the spiral is conductive (metal) such as copper etc., and the handle is dielectric such as Teflon® or plastic such as polyether ether ketone (PEEK). Teflon® is a registered trademark of E.I. Du Pont De Nemours and Company Corporation, Delaware, U.S.A. PEEK™ is also a trademark of Zeus, Inc. of Orangeburg, S.C., U.S.A. Center conductor 110 is comprised with probe 125, which, in embodiments, probe 125 is metal. Probe 125 has length L_{probe} 130, and spiral has length Lₛₚᵢᵣₐₗ 140. Toward probe end opposite spiral 105 is sensor 135. In this embodiment, the spiral-dipole antenna (one loop-dipole antenna) has only one turn (loop) comprising this antenna element. Other embodiments vary from one loop.

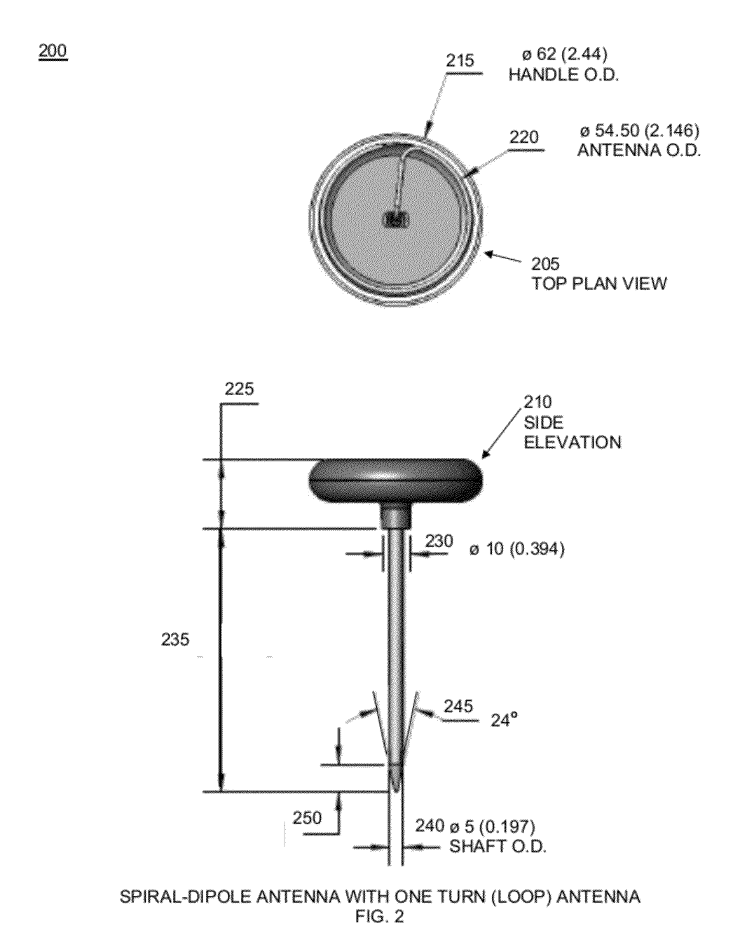

FIG. 2 depicts plan and elevation views 200 of a spiral-dipole antenna embodiment with a one turn (loop) antenna configured in accordance with the present invention. Portrayed are top plan view 205 and side elevation view 210. Embodiment particulars include handle 215 outer diameter of 2.44 inches and antenna 220 showing an outer diameter of 2.146 inches. Side elevation 210 includes handle portion height 225 (0.984 inches in an embodiment). Handle shaft connection 230 to probe has a 0.394 inch diameter in embodiments. Probe shaft length 235 is 3.740 inches in an embodiment. Probe shaft outer diameter 240 is 0.197 inches in embodiments. In embodiments, probe shaft has a tip tapered 245 at 24 degrees. In embodiments, the tapered portion of the probe shaft tip 250 is 0.394 inches long.

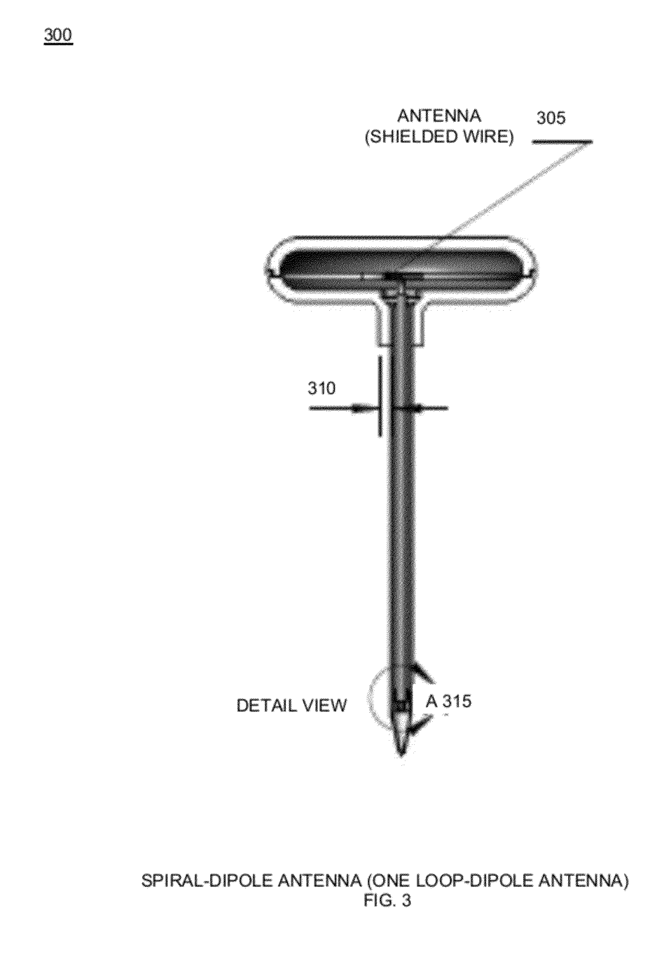

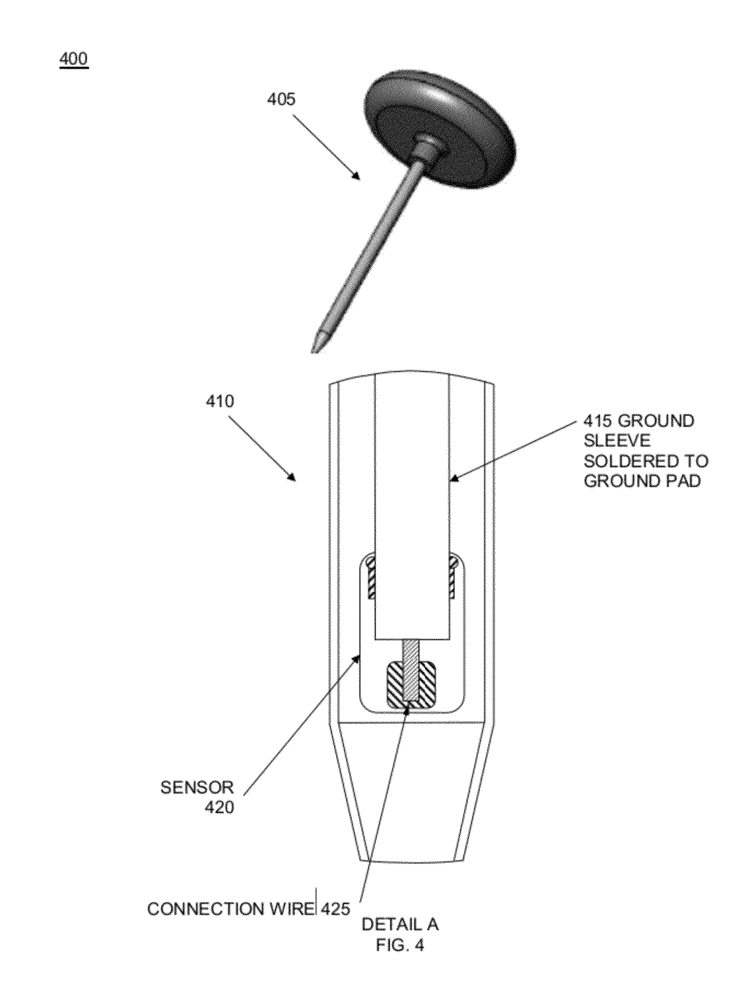

FIG. 3 depicts an elevation detail view 300 of a shielded wire spiral-dipole antenna embodiment with a one turn (loop) antenna. Antenna 305 is within handle affixed to probe shaft. Handle shaft connection to probe differential radius 310 is 0.098 inches in embodiments. Tip section contains SAW sensor depicted by cross section detail A 315 to be shown in FIG. 4.

FIG. 4 depicts views 400 of perspective and elevation sensor-end detail of an embodiment configured in accordance with the present invention. Underside perspective view 405 presents the intersection of the handle and the probe shaft. Probe shaft end detail 410 shows cross section detail A 315 of FIG. 3. Ground sleeve is soldered to ground pad 415. Sensor component 420 is located proximate connection wire 425. For a semi-rigid cable, the inner conductor can be copper or other conductor material in embodiments.

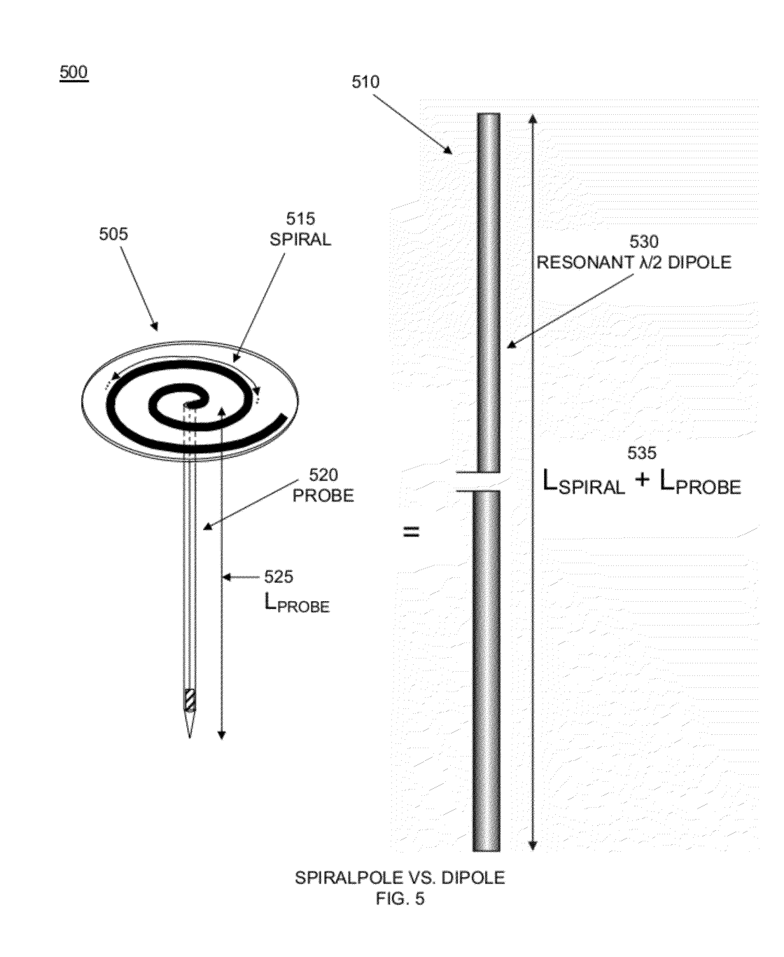

FIG. 5 depicts views 500 of an antenna geometry embodiment perspective and corresponding dipole representation configured in accordance with the present invention. In perspective 505, a spiral antenna is shown with a corresponding dipole representation 510. Perspective 505 portrays spiral 515 of antenna element having length Lₛₚᵢᵣₐₗ. Probe 520 has length L_{probe}. Dipole representation 510 represents a resonant one-half wavelength (λ/2) resonant dipole 530 with length 535 of Lₛₚᵢᵣₐₗ plus L_{probe}.

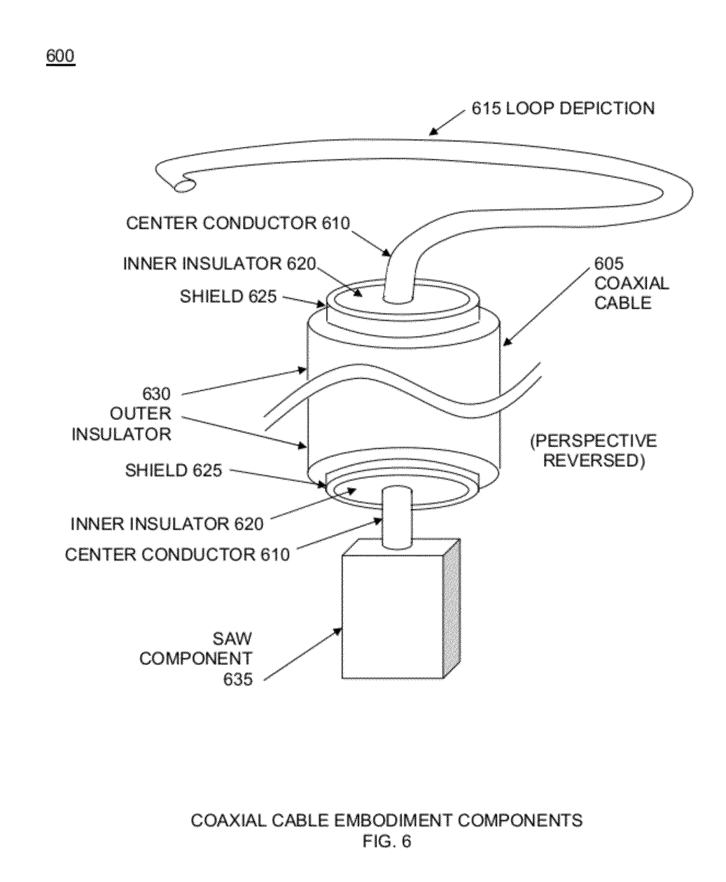

FIG. 6 depicts a perspective diagram 600 of a coaxial cable component embodiment configured in accordance with the present invention. Coaxial cable 605 spans between antenna and sensor. Coaxial center conductor 610 is formed as antenna element 615. Coaxial cable inner insulator 620, shield 625, and outer insulator 630 are shown for antenna and sensor ends. SAW (or AWD) sensor component 635 is at distal end from antenna. In embodiments, the cable is flexible, semi-flexible, and rigid. In embodiments, outer insulator 630, outer jacket or conductor 625 & 620 are combined and comprise shielding. In embodiments, shield 625 is connected to the shaft, providing a common ground connection. For embodiments, stainless steel or other conductive tubing is used as an outer conductor. Teflon® tubing is placed inside the outer tubing and serves as insulation for embodiments. Other insertions are used in embodiments, such as shrink-tubing. Within the Teflon® tubing is a Teflon® wire where the Teflon® tube is sized to American Wire Gauge (AWG) dimensions. Embodiment component suppliers comprise Zeus, Inc. of Orangeburg, S.C., U.S.A. Other inner conductors can be used. In embodiments, impedance is thereby maintained, with decreased cost.

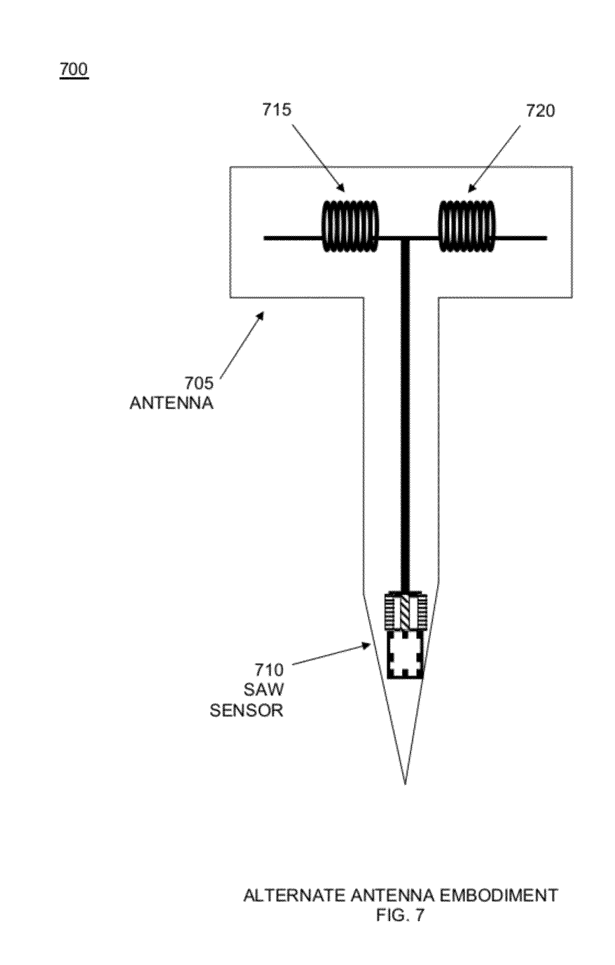

FIG. 7 depicts a cross-section view 700 of another embodiment configured in accordance with the present invention. Antenna 705 is in a T-handle probe section connecting to probe tip comprising SAW sensor 710. Antenna 705 comprises first loop antenna component 715 and second loop antenna component 720. In embodiments, loop antenna components 715 and 720 comprise multiple loop turns. In embodiments, loop antenna components 715 and 720 are symmetric.

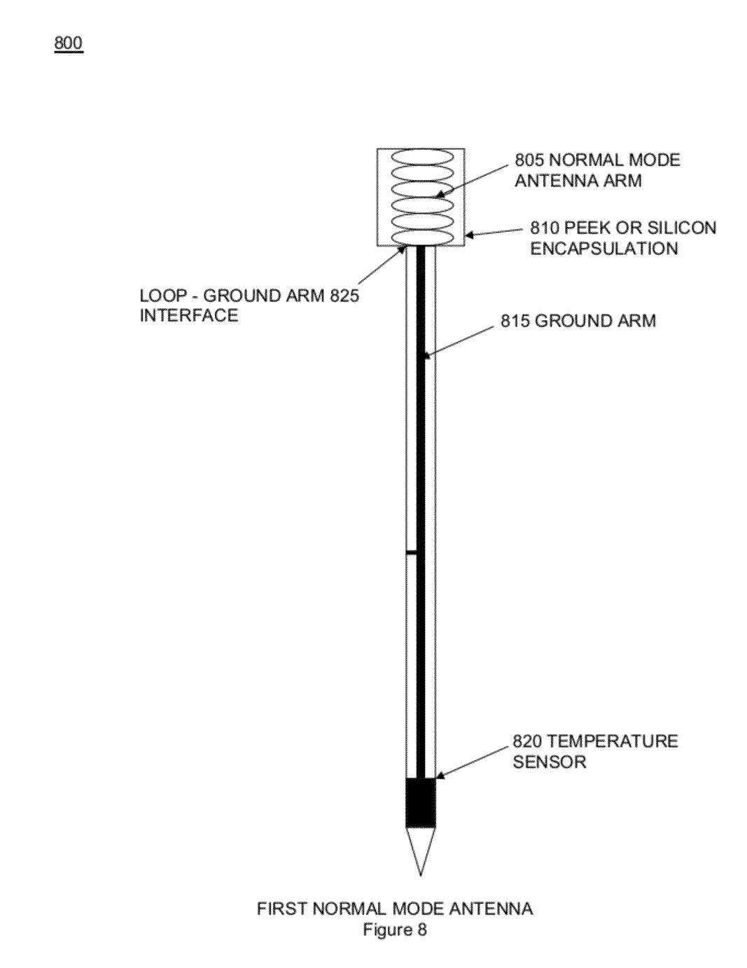

FIG. 8 depicts a cross-section view 800 of another embodiment configured in accordance with the present invention. Normal mode antenna arm 805 is encapsulated 810 in PEEK or silicon in embodiments. Ground arm 815 extends between and connects antenna arm 805 and temperature sensor 820. In embodiments, antenna arm 805 comprises a plurality of helical spiral portions and interfaces with ground arm 815 at the termination of the proximate loop 825.

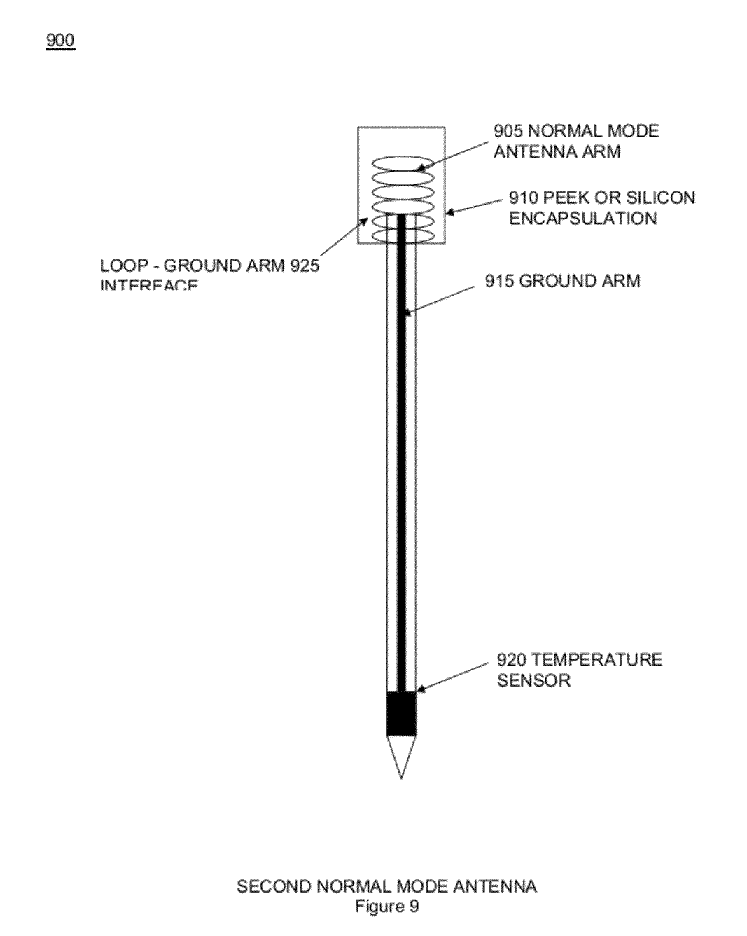

FIG. 9 depicts a cross-section view 900 of another embodiment configured in accordance with the present invention. Normal mode antenna arm 905 is encapsulated 910 in PEEK or silicon in embodiments. Ground arm 915 extends between and connects antenna arm 905 and temperature sensor 920. In embodiments, antenna arm 905 comprises a plurality of loop spiral portions and interfaces with ground arm 915 at an intermediate location 925 between terminal ends of antenna element of antenna arm 905.

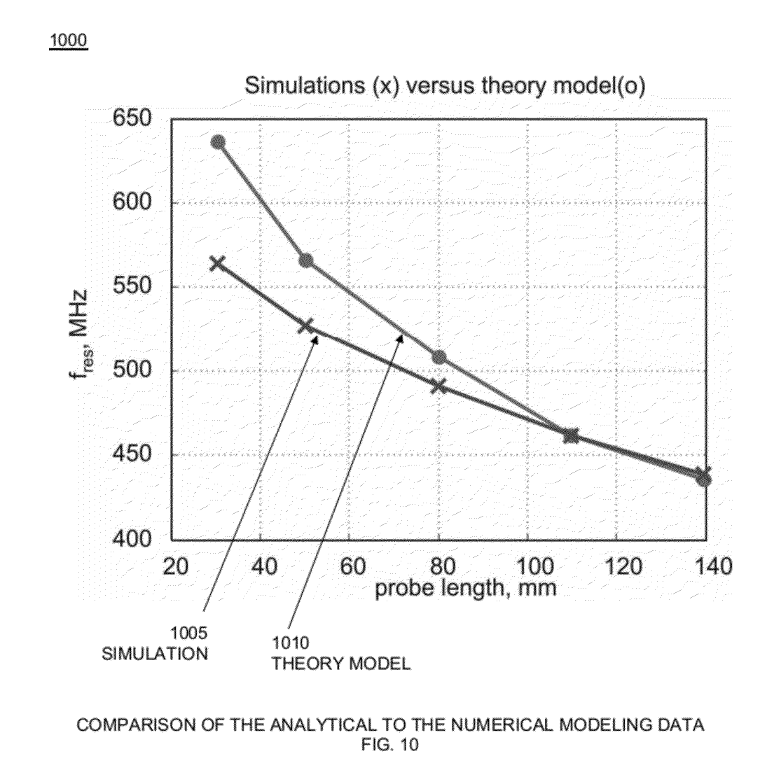

FIG. 10 is a graph 1000 of theoretical versus calculated resonant frequency results for embodiments configured in accordance with the present invention. Simulation values 1005 and theory model values 1010 are shown for probe lengths from 20 mm to 140 mm and resonant frequencies between 400 MHz and 650 MHz. Graph 1000 provides a comparison of the analytical data to the numerical modeling data. More particularly, this shows theory data versus finite element method (FEM) data for an antenna with a length of the spiral of 205 mm and a probe length varying from 30 mm to 140 mm. Confirmation of equations (1) and (2) is given by comparison with the numerical simulations as produced in ANSYS HFSS. Agreement shown is good, improving toward probe lengths of 100 mm to 140 mm.

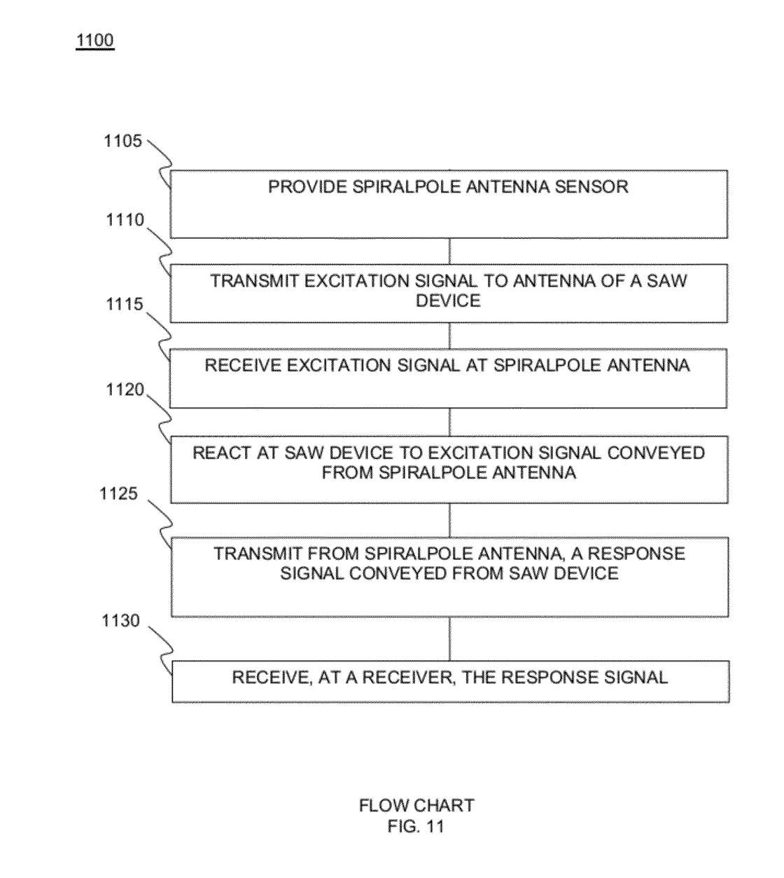

FIG. 11 is a flow chart 1100 of a method configured in accordance with the present invention. Steps comprise providing a spiralpole antenna sensor device 1105; transmitting an excitation signal to antenna of a SAW (or AWD) device 1110; receiving the excitation signal at the spiralpole antenna 1115; reacting, at the SAW (or AWD) device, to the excitation signal conveyed from the spiralpole antenna 1120; transmitting from the spiralpole antenna, a response signal conveyed from the SAW device 1125; and receiving, at a receiver, the response signal 1135.

Application environments comprise ovens including, but not limited to, residential microwave ovens, commercial ovens, and conventional thermal ovens. In nonlimiting embodiments the probe is flexible, semi-rigid, and or rigid. The handle, in embodiments, is one-piece, molded over the antenna component. For embodiments, the sensor comprises at least one SAW resonator. The probe antenna radiation pattern, in embodiments, is omnidirectional, multi-lobed, or elliptical. For embodiments, the probe radiation pattern is circularly polarized or of mixed polarization. Antenna radiation performance is considered for the probe in free space, partially embedded, and fully embedded in a subject for temperature measurement. For embodiments, the antenna is mismatched but provides a broad radiation pattern. For further embodiments, the antenna is mismatched and unbalanced. System embodiments comprise matched and unmatched circuits with or without matching components such as a loading coil. In embodiments, antenna components are orthogonal to the probe shaft. In other embodiments, antenna components are not orthogonal to the probe shaft. Antenna embodiments provide a single loop antenna element and multiple, spiral arm, elements. Frequency ranges, in embodiments, comprise about approximately 400 MHz to 700 MHz. Probe lengths, in embodiments, comprise about approximately 15 mm to 200 mm. Transmitter/receiver antennas can be unitary or of multiple component construction. Benefits comprise direction independence of performance; i.e. movement or orientation of the temperature subject does not impact the accuracy or resolution of the temperature measurement. Probe configurations support shorter lengths, smaller overall size for given performance, eased insertion into temperature subjects, support for multiple probes through differential operating frequencies of AWD components in multiple probes, higher field strengths (13.5 dB in embodiments), and sensor evaluation for ‘doneness’ in addition to raw temperature. In embodiments, the measurand includes and is other than temperature. One or more measurands are detected, implemented with one or more acoustic wave devices (AWDs). In embodiments, the SAW sensor is extended to include other AWDs in addition to those considered as ‘surface’ acoustic wave devices. Nonlimiting examples include those sensor devices disclosed in U.S. Pat. Nos. 6,033,852, 7,569,971, 7,667,369, 7,633,206, 7,855,564, 11/875,162, 12/610,642, 12/429,300, 12/884,931, and 61/411,130 (provisional application), whose contents are herein incorporated in their entirety by reference.

The foregoing description of the embodiments of the invention has been presented for the purposes of illustration and description. Each and every page of this submission, and all contents thereon, however characterized, identified, or numbered, is considered a substantive part of this application for all purposes, irrespective of form or placement within the application. This specification is not intended to be exhaustive or to limit the invention to the precise form disclosed. Many modifications and variations are possible in light of this disclosure.

What is claimed is:

1. A probe system for wireless sensing of at least one measurand, said system comprising:
a spiral-dipole (spiralpole) antenna component;
a probe shaft comprising electrical connection;
an acoustic wave device (AWD) sensor in electrical communication with said spiralpole antenna through said probe shaft;
wherein said system is configured to communicate with an excitation signal generator and response signal receiver.

2. The system of claim 1, wherein said AWD is a surface acoustic wave (SAW) device.

3. The system of claim 1, wherein said AWD is a surface acoustic wave (SAW) resonator device.

4. The system of claim 1, wherein said measurand comprises temperature.

5. The system of claim 4, further comprising at least one measurand in addition to temperature, to which said acoustic wave device is sensitive.

6. The system of claim 1, wherein said at least one measurand is a measurand other than temperature, to which said acoustic wave device is sensitive.

7. The system of claim 1, wherein said spiral-dipole antenna component is non-orthogonal to said probe shaft.

8. The system of claim 1, wherein multiple said probes operate cooperatively through differential operating frequencies of AWD components in each of said multiple probes.

9. The system of claim 1, wherein radiation pattern of said probe is omnidirectional.

10. The system of claim 1, wherein performance is direction-independent; whereby movement and orientation of temperature measurement subject does not impact accuracy or resolution of temperature measurement.

11. The system of claim 1, wherein said spiral-dipole antenna is mismatched, whereby radiation pattern is broad.

12. The system of claim 1, wherein said spiral-dipole antenna component comprises a helical coil.

13. The system of claim 1, wherein said spiral-dipole antenna component comprises a helical coil and interfaces with ground arm at a termination of a proximate loop.

14. The system of claim 1, wherein said spiral-dipole antenna component comprises a helical coil and interfaces with ground arm at an intermediate location between terminal ends of antenna element of said spiral-dipole antenna component.

15. A probe device for wireless sensing of at least one measurand, said device comprising:
a spiral-dipole (spiralpole) antenna component;
a probe shaft component in electrical communication with said spiral-dipole (spiralpole) antenna component;
an acoustic wave device (AWD) sensor in electrical communication with said spiralpole antenna through said probe shaft;
wherein said device is configured to communicate with an excitation signal generator and response signal receiver.

16. A method for wireless sensing comprising:
providing a spiral-dipole (spiralpole) antenna sensor device;
transmitting an excitation signal to antenna of an acoustic wave device (AWD);
receiving said excitation signal at said spiralpole antenna;
reacting, at said AWD, to said excitation signal conveyed from said spiralpole antenna;
transmitting from said spiralpole antenna, a response signal conveyed from said AWD; and
receiving, at a receiver, said response signal.

17. The method of claim 16, wherein operating frequency range is about 400 MHz to about 700 MHz.

18. The method of claim 16, wherein transmitter antenna of said transmitting step and receiving antenna of said receiving step comprise unitary components.

19. The method of claim 16, wherein transmitter antenna of said transmitting step and receiving antenna of said receiving step comprise multiple components

20. The method of claim 16, whereby operational field strengths of about 13.5 dB are produced.
